(19) United States
(12) Patent Application Publication
(10) Pub. No.: US 2009/0087552 A1
(43) Pub. Date: Apr. 2, 2009

(54) METHOD OF PRODUCING HEAT-SENSITIVE TRANSFER IMAGE-RECEIVING SHEET

(75) Inventors: Tomoyuki Koide, Tokyo (JP); Kenji Naoi, Ashigarakami-gun (JP); Kazuaki Oguma, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/239,533

(22) Filed: Sep. 26, 2008

(30) Foreign Application Priority Data
Sep. 27, 2007 (JP) 2007-252742

(51) Int. Cl. B05D 1/34; B41M 5/025

(52) U.S. Cl. 427/151; 427/150

(57) ABSTRACT

A method of producing a heat-sensitive transfer image-receiving sheet having, on a support, a heat insulation layer and a receptor layer, having a step of: forming both the heat insulation layer and the receptor layer by an aqueous simultaneous multilayer coating; wherein the heat insulation layer has at least one kind of hollow polymer particles and at least one resin having a glass transition temperature (Tg) in the range from 20° C. to 80° C.

### FIELD OF THE INVENTION

The present invention relates to a method of producing a heat-sensitive transfer image-receiving sheet. More specifically, the present invention relates to a method of producing a heat-sensitive transfer image-receiving sheet that is able to provide a high density, to seldom cause a trouble in an image, and to avoid remaining traces of carrier roller.

### BACKGROUND OF THE INVENTION

Various heat transfer recording methods have been known so far. Among these methods, dye diffusion transfer recording systems attract attention as a process that can produce a color hard copy having an image quality closest to that of silver halide photography. Moreover, this system has advantages over silver halide photography: it is a dry system, it enables direct visualization from digital data, it makes reproduction simple, and the like.

In the dye diffusion transfer recording systems, a colorant (hereinafter also referred to as “a dye” or “an ink”)-containing heat-sensitive transfer sheet (hereinafter also simply referred to as “an ink sheet”) and a heat-sensitive transfer image-receiving sheet (hereinafter also simply referred to as “an image-receiving sheet”) are superposed, and the ink sheet is heated using a thermal head with which heat generation can be controlled by electric signals. Thereby a colorant in the ink sheet is transferred to the image-receiving sheet to record image information. More specifically, a transferred color image with a continuous change in color shading can be obtained by recording three colors including cyan, magenta and yellow, or four colors including black in addition to the three colors in the manner of one over another.

As a support of the image-receiving sheet of this system, ordinary paper can be used. In this case, it is possible to produce the image-receiving sheet at low cost. With respect to such an image-receiving sheet using paper as the support, in order to improve the cushion characteristics (cushion properties) of the support, a layer having high cushion characteristics (e.g., a foaming layer made of a resin and a foaming agent) is usually formed between the support and an ink receptor layer (hereinafter also simply referred to as “a receptor layer”) to give more cushion characteristics to the support, thereby improving the contact between the image-receiving sheet and a transfer sheet. Further, an interlayer is disposed between the foaming layer and the receptor layer, so that the foaming layer is prevented from collapsing by heat at the time of printing. However, in the previous image-receiving sheet, the foaming layer has been formed by coating with an organic solvent-based resin-coating liquid. Thereby the coating liquid destroys air bubbles and voids, so that desired cushion properties can not be attained. A lack of the cushion properties causes troubles such that low spots (thin spots) and image unevenness generate at the time of image formation, or a heat insulation property of the foaming layer reduces, so that a quantity of heat necessary for dye transfer diffuses to the back side direction of the image-receiving sheet, which invites reduction in sensitivity at the time of printing.

Regarding the improvement of such troubles, for example, JP-A-8-25813 (“JP-A” means unexamined published Japanese patent application) discloses that an interlayer between a foaming layer and a receptor layer is formed by an aqueous coating liquid, so that a delicate unevenness of the foaming layer is copied accurately to the surface shape of the receptor layer. However, according to this method, disadvantages arise such that in addition to unsatisfactory sensitivity and high cost, a lot of image failures occur because a support is coated with a foaming layer, and after drying it by heat, the foaming layer is coated with a receptor layer, so that unevenness is formed on the surface of the receptor layer. Further, for example, JP-A-11-321128 discloses that an interlayer containing hollow particles and an organic solvent-resistant polymer as main components is formed between a support and a receptor layer. However, according to this method, disadvantages also arise such that in addition to unsatisfactory sensitivity and high cost, a lot of image failures occur because a support is coated with a foaming layer and a resin layer, and after drying them by heat, these layers are coated on a receptor layer, so that unevenness is formed on the surface of the receptor layer, and a coat peeling may occur owing to a bad handling because of unsatisfactory adherence between layers.

Further, according to the invention disclosed in Japanese Registered Patent No. 3447338, it is possible to achieve print quality with no image failure by controlling the lowest coat-forming temperature of the coat-forming binder in the layer containing hollow polymers at 25° C. or more, and also by setting a content of the hollow polymers within the range of from 4% by mass to 30% by mass. However, at the time of high-speed printing according to a recent requirement, a new disadvantage arises such that a trace of the carrier roller is actualized owing to enhancement of carrier roller pressure necessary for high-speed carrier.

### SUMMARY OF THE INVENTION

The present invention resides in a method of producing a heat-sensitive transfer image-receiving sheet having, on a support, a heat insulation layer and a receptor layer, comprising a step of:

forming both the heat insulation layer and the receptor layer by an aqueous simultaneous multilayer coating;

wherein the heat insulation layer comprises at least one kind of hollow polymer particles and at least one resin having a glass transition temperature (Tg) in the range from 20° C. to 80° C.

Other and further features and advantages of the invention will appear more fully from the following description.

### DETAILED DESCRIPTION OF THE INVENTION

The present invention provides the following means:
(1) A method of producing a heat-sensitive transfer image-receiving sheet having, on a support, a heat insulation layer and a receptor layer, comprising a step of:

forming both the heat insulation layer and the receptor layer by an aqueous simultaneous multilayer coating;

wherein the heat insulation layer comprises at least one kind of hollow polymer particles and at least one resin having a glass transition temperature (Tg) in the range from 20° C. to 80° C.
(2) The method of producing a heat-sensitive transfer image-receiving sheet as described in item (1), wherein a solid content of the hollow polymer in the heat insulation layer is in the range of from 50% by mass to 95% by mass.
(3) The method of producing a heat-sensitive transfer image-receiving sheet as described in item (1) or (2), wherein a moisture content of the image-receiving sheet measured according to JIS P 8127 is in the range of from 2% by mass to 8% by mass.
(4) The method of producing a heat-sensitive transfer image-receiving sheet as described in any one of items (1) to (3), wherein at least one compound represented by formula (I), (II) or (III) is contained in any one of the heat insulation layer and the receptor layer.

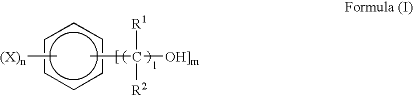

wherein R¹ and R², which may be the same or different, each represent a hydrogen atom, a hydroxy group, or an alkyl group having 1 to 8 carbon atoms; X represents a hydrogen atom, a halogen atom, a nitro group, a cyano group, an aryl group, an alkyl group having 1 to 8 carbon atoms, an alkenyl group having 2 to 8 carbon atoms, an aralkyl group, an alkoxy group, —COR³, —SO₃R⁴, or —N(R⁵)R⁶; R³ and R⁴, which may be the same or different, each represent a hydrogen atom, -OM, an alkyl group having 1 to 8 carbon atoms, an alkoxy group having 1 to 8 carbon atoms, or —N(R⁷)R⁸; R⁵ and R⁶, which may be the same or different, each represent a hydrogen atom, an alkyl group having 1 to 8 carbon atoms, —COR⁹, or —SO₂R¹⁰; R⁹ and R¹⁰, which may be the same or different, each represent an alkyl group having 1 to 8 carbon atoms, or —N(R¹¹)R¹²: R⁷, R⁸, R¹¹ and R¹², which may be the same or different, each represent a hydrogen atom, or an alkyl group having 1 to 8 carbon atoms; M represents a hydrogen atom, an alkali metal atom, or atoms necessary for forming a univalent cation; 1 represents an integer of 2 to 6; m represents an integer of 1 to 4; n represents an integer of (6-m); and when a plurality of R¹, R² or X are present, the plurality of R¹, R² or X may be different from each other respectively;

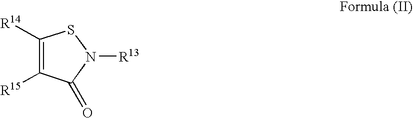

wherein R¹³ represents a hydrogen atom, an alkyl group having 1 to 8 carbon atoms, an alkenyl group, an aralkyl group, an aryl group, a heterocyclic group or the following group

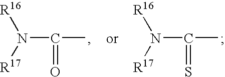

R¹⁴ and R¹⁵, which may be the same or different, each represent a hydrogen atom, a halogen atom, an alkyl group having 1 to 8 carbon atoms, an aryl group, a cyano group, a heterocyclic group, an alkylthio group, an alkylsulfoxyl group or an alkylsulfonyl group; and R¹⁴ and R¹⁵ may bond together to form an aromatic ring;

R¹⁶ and R¹⁷, which may be the same or different, each represent a hydrogen atom, an alkyl group having 1 to 8 carbon atoms, an aryl group, or an aralkyl group;

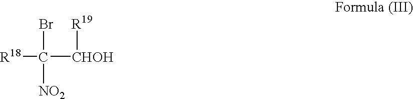

wherein R¹⁸ represents a hydrogen atom, an alkyl group having 1 to 8 carbon atoms, or a hydroxymethyl group; and R¹⁹ represents a hydrogen atom or an alkyl group having 1 to 8 carbon atoms.
(5) The method of producing a heat-sensitive transfer image-receiving sheet as described in any one of items (1) to (4), wherein an interlayer is disposed between the support and the heat insulation layer, or between the heat insulation layer and the receptor layer.

### DETAILED DESCRIPTION OF THE INVENTION

The present invention is explained in detail below.

The heat-sensitive transfer image-receiving sheet of the present invention (hereinafter also referred to as “the image-receiving sheet of the present invention”) preferably has at least one receptor layer (hereinafter also referred to as “ink receptor layer” or “dye receptor layer”) on a support, and at least one heat insulation layer (hereinafter also referred to as “porous layer”) between the support and the receptor layer. Further, as one of the preferred embodiments according to the present invention, between the support and the receptor layer, there may be formed an interlayer having various functions such as white back ground controlling, antistatic, adhesion, and leveling functions. Further, a release layer may be formed at the outermost layer on the side of which a heat-sensitive transfer sheet is superposed.

In the present invention, it is preferred that the receptor layer and the heat insulation layer are coated by an aqueous simultaneous multilayer coating. Coating of these layers may be performed by an ordinary method such as slide coat, or curtain coat.

On the side of the support opposite to the receptor layer coating side, a curl adjusting layer, a recording layer or a static adjusting layer may be disposed.

The heat insulation layer that is coated in the heat-sensitive transfer image-receiving sheet of the present invention may be a single layer or double or more multiple layers. The heat insulation layer is disposed between the support and the receptor layer.

In the heat-sensitive transfer image-receiving sheet of the present invention, the heat insulation layer contains hollow particles, preferably hollow polymer particles.

The hollow polymer particles in the present invention are polymer particles having voids inside of the particles. The hollow polymer particles are preferably aqueous dispersion. Examples of the hollow polymer particles include (1) non-foaming type hollow particles obtained in the following manner: a dispersion medium such as water is contained inside of a capsule wall formed of a polystyrene, acrylic resin, or styrene/acrylic resin, and, after a coating liquid is applied and dried, the water in the particles is vaporized out of the particles, with the result that the inside of each particle forms a hollow; (2) foaming type microballoons obtained in the following manner: a low-boiling-point liquid such as butane and pentane, is encapsulated in a resin constituted of any one of polyvinylidene chloride, polyacrylonitrile, polyacrylic acid, and polyacrylate, or their mixture or polymer, and after the resin coating material is applied, it is heated to expand the low-boiling-point liquid inside of the particles, whereby the inside of each particle is made to be hollow; and (3) microballoons obtained by foaming the above (2) under heating in advance, to make hollow polymer particles.

Specific examples of the above (1) include Rohpake 1055, manufactured by Rohm and Haas Co.; Boncoat PP-1000, manufactured by Dainippon Ink and Chemicals, Incorporated; SX866(B), manufactured by JSR Corporation; and Nippol MH5055, manufactured by Nippon Zeon (all of these product names are trade names). Specific examples of the above (2) include F-30, and F-50, manufactured by Matsumoto Yushi-Seiyaku Co., Ltd. (all of these product names are trade names). Specific examples of the above (3) include F-30E, manufactured by Matsumoto Yushi-Seiyaku Co., Ltd, and Expancel 461DE, 551DE, and 551DE20, manufactured by Nippon Ferrite (all of these product names are trade names).

Of these, non-foaming hollow polymer particles of the foregoing (1) are preferred. If necessary, use can be made of a mixture of two or more kinds of polymer particles.

The average particle diameter (particle size) of the hollow polymer particles is preferably 0.1 to 5.0 μm, more preferably 0.2 to 3.0 μm, and particularly preferably 0.3 to 2.0 μm.

The hollow ratio (percentage of void) of the hollow polymer particles is preferably in the range of from about 20% to about 70%, and particularly preferably from 20% to 50%.

In the present invention, the particle size of the hollow polymer particle is calculated after measurement of the circle-equivalent diameter of the periphery of particle under a transmission electron microscope. The average particle diameter is determined by measuring the circle-equivalent diameter of the periphery of at least 300 hollow polymer particles observed under the transmission electron microscope and obtaining the average thereof.

The hollow ratio of the hollow polymer particles is calculated by the ratio of the volume of voids to the volume of a particle.

The glass transition temperature (Tg) of the hollow polymer particles that can be used in the heat-sensitive transfer image-receiving sheet of the present invention is preferably 70 to 200° C., more preferably 90 to 180° C.

The heat insulation layer containing a hollow polymer further contains, as a binder, a polymer resin having a glass transition temperature (Tg) in the range from 20° C. to 80° C. with a preferable range of from 25° C. to 75° C. When Tg is lower than 20° C., it is impossible to obtain an image having a high maximum density, neither the image evenness nor the quality of roller trace are improved. When Tg is higher than 80° C., it is possible to obtain an image having a high maximum density, but neither the image evenness nor the quality of roller trace are improved.

A preferably exemplified binder that is used for the aqueous coating necessary to the present invention is latex polymer as set forth below. The latex may be used solely or in a mixture.

A thickness of the heat insulation layer containing the hollow polymer particles is preferably from 5 to 50 μm, more preferably from 5 to 40 μm.

In the present invention, it is preferred that the heat insulation layer containing a hollow polymer contains hollow polymer particles with a solid content of 50% or more after drying, with more preferable solid content of 60% or more. The upper limit of the solid content by mass is preferably 95% or less. If the solid content by mass is too low, both sensitivity and density reduce owing to lack of heat insulation property. On the other hand, when the solid content by mass is too high, crazing occurs owing to a short of binder. However, there is practically no problem.

The heat insulation layer according to the present invention contains a polymer resin having a glass transition temperature (Tg) in the range from 20° C. to 80° C. The resin herein used is preferably water-dispersed latex from a viewpoint of aqueous coating. There is no particular limitation to the kind (for example, species, compositions, and molecular weight) of the polymer resin itself. Trade names of various kinds of latex polymer are exemplified below. However, the present invention is not intended to be limited thereto.

Examples of the acrylic-series polymers include Nipol LX855 (P-17: Tg 36° C.), and 857x2 (P-18: Tg 43° C.) (trade names, manufactured by Nippon Zeon Co., Ltd.); Voncoat R3370 (P-19: Tg 25° C.) (trade name, manufactured by Dai-Nippon Ink & Chemicals, Inc.); Julimer ET-410 (P-21: Tg 44° C.) (trade name, manufactured by Nihon Junyaku K.K.); and AE116 (P-22: Tg 50° C.), AE119 (P-23: Tg 55° C.), AE121 (P-24: Tg 58° C.), AE125 (P-25: Tg 60° C.), AE134 (P-26: Tg 48° C.), AE137 (P-27: Tg 48° C.), AE140 (P-28: Tg 53° C.), and AE173 (P-29: Tg 60° C.) (trade names, manufactured by JSR Corporation), Aron A-104 (P-30: Tg 45° C.) (trade name, manufactured by Toagosei Co., Ltd.).

Examples of the polyesters include FINETEX ES650, 611, 675, and 850 (trade names, manufactured by Dainippon Ink and Chemicals, Incorporated); WD-size, and WMS (trade names, manufactured by Eastman Chemical Ltd.); A-110, A-115GE, A-120, A-121, A-124GP, A-124S, A-160P, A-210, A-215GE, A-510, A-513E, A-515GE, A-520, A-610, A-613, A-615GE, A-620, WAC-10, WAC-15, WAC-17XC, WAC-20, S-110, S-110EA, S-111SL, S-120, S-140, S-140A, S-250, S-252G, S-250S, S-320, S-680, DNS-63P, NS-122L, NS-122LX, NS-244LX, NS-140L, NS-141LX, and NS-282LX (trade names, manufactured by Takamatsu Yushi K.K.); Aronmelt PES-1000 series, and PES-2000 series (trade names, manufactured by Toagosei Co., Ltd.); Vylonal MD-1100, MD-1200, MD-1220, MD-1245, MD-1250, MD-1335, MD-1400, MD-1480, MD-1500, MD-1930, and MD-1985 (trade names, manufactured by Toyobo Co., Ltd.); and Ceporjon ES (trade name, manufactured by Sumitomo Seika Chemicals Co., Ltd.).

Examples of the polyurethanes include HYDRAN AP10, AP20, AP30, AP40, and 101H, Vondic 1320NS and 1610NS (trade names, manufactured by Dainippon Ink and Chemicals, Incorporated); D-1000, D-2000, D-6000, D-4000, and D-9000 (trade names, manufactured by Dainichi Seika Color & Chemicals Mfg. Co., Ltd.); NS-155X, NS-310A, NS-310X, and NS-311X (trade names, manufactured by Takamatsu Yushi K.K.); and Elastron (trade name, manufactured by Dai-ichi Kogyo Seiyaku Co., Ltd.).

Examples of the rubbers include LACSTAR 7310K, 3307B, 4700H, and 7132C (trade names, manufactured by Dainippon Ink & Chemicals Incorporated); and Nipol LX416, LX410, LX430, LX435, LX110, LX415A, LX438C, 2507H, LX303A, LX407BP series, V1004, and MH5055 (trade names, manufactured by Nippon Zeon Co., Ltd.).

Examples of polyvinyl chloride polymers include G351 and G576 (trade names, manufactured by Nippon Zeon Co., Ltd.); VINYBLAN 240, 270, 277, 375, 386, 609, 550, 601, 602, 630, 660, 671, 683, 680, 680S, 681N, 685R, 277, 380, 381, 410, 430, 432, 860, 863, 865, 867, 900, 900GT, 938 and 950 (trade names, manufactured by Nissin Chemical Industry Co., Ltd.); SOLBIN C, SOLBIN CL, SOLBIN CH, SOLBIN CN, SOLBIN C5, SOLBIN M, SOLBIN MF, SOLBIN A, SOLBIN AL (trade names, manufactured by Nissin Chemical Industry Co., Ltd.); S-LEC A, S-LEC C and S-LEC M (trade names, manufactured by Sekisui Chemical Co., Ltd.); and DENKA VINYL 1000GKT, DENKA VINYL 1000L, DENKA VINYL 1000CK, DENKA VINYL 1000A, DENKA VINYL 1000LK2, DENKA VINYL 1000AS, DENKA VINYL 1000GS, DENKA VINYL 1000LT3, DENKA VINYL 1000D and DENKA VINYL 1000W (trade names, manufactured by Denki Kagaku Kogyo Kabushiki Kaisha).

Examples of polyvinylidene chloride polymers include L502, L513 (trade names, manufactured by ASAHI KASEI CORPORATION), and D-5071 (trade name, manufactured by Dainippon Ink and Chemicals, Incorporated).

Examples of the polyolefins include Chemipearl S120, SA100, and V300 (trade names, manufactured by Mitsui Petrochemical); Voncoat 2830, 2210, and 2960 (trade names, manufactured by Dainippon Ink and Chemicals, Incorporated); and Zaikusen and Ceporjon G (trade names, manufactured by Sumitomo Seika Chemicals Co., Ltd.). Examples of the copolymer nylons include Ceporjon PA (trade name, manufactured by Sumitomo Seika Chemicals Co., Ltd.).

Examples of the polyvinyl acetates include VINYBLAN 1080, 1082, 1085W, 1108W, 1108S, 1563M, 1566, 1570, 1588C, A22J7-F2, 1128C, 1137, 1138, A20J2, A23J1, A23J1, A23K1, A23P2E, A68J1N, 1086A, 1086, 1086D, 1108S, 1187, 1241LT, 1580N, 1083, 1571, 1572, 1581, 4465, 4466, 4468W, 4468S, 4470, 4485LL, 4495LL, 1023, 1042, 1060, 1060S, 1080M, 1084W, 1084S, 1096, 1570K, 1050, 1050S, 3290, 1017AD, 1002, 1006, 1008, 1107L, 1225, 1245L, GV-6170, GV-6181, 4468W, and 4468S (trade names, manufactured by Nissin Chemical Industry Co., Ltd.).

Preferable examples of the latex polymer that can be used in the present invention may include polylactates, polyurethanes, polycarbonates, polyesters, polyacetals, SBR's, and polyvinyl chlorides. It is more preferable to include polyvinyl chlorides, polyesters, polycarbonates, and SBR's among these compounds. It is further preferable to include polyvinyl chlorides, polyesters, and SBR's among these compounds. It is especially preferable to include polyvinyl chlorides. Among these, vinyl chloride/acrylic copolymer latex polymer and vinyl chloride/vinyl acetate copolymer latex polymer are preferable, and vinyl chloride/acrylic copolymer latex polymer is particularly preferable.

These latex polymers may be used singly, or two or more of these polymers may be blended, if necessary. In the present invention, it is preferable to blend two or more of these latex polymers.

In the present invention, both a receptor layer and a heat insulation layer are coated with an aqueous coating liquid. When a plurality of the receptor layers and/or a plurality of the heat insulation layers are prepared, it is essential that all coating liquids of these layers are coated by an aqueous simultaneous multilayer coating, and then dried. The “aqueous” here means the following two cases. One is the case where the material included in the layer to be coated contains either a water-soluble polymer or a latex polymer. Another is the case where 60% by mass or more of the solvent (dispersion medium) of the coating liquid is water. As a component other than water in the coating liquid, a water miscible organic solvent may be used, such as methyl alcohol, ethyl alcohol, isopropyl alcohol, methyl cellosolve, ethyl cellosolve, dimethylformamide, ethyl acetate, diacetone alcohol, furfuryl alcohol, benzyl alcohol, diethylene glycol monoethyl ether, and oxyethyl phenyl ether, but is not limited thereto.

According to one of preferable embodiments of the present invention, a moisture content of the heat-sensitive transfer image-receiving sheet measured according to JIS P 8127 is in the range of from 2% by mass to 8% by mass. Generally there is a concern such that crack occurs under the low humidity condition, while adhesion or moisture dependency of curl occur under the high humidity condition. In the present invention, however, effects are attained even outside the foregoing range. Further, higher quality prints can be obtained in the foregoing range. The moisture content is more preferably in the range of from 2% by mass to 7% by mass and furthermore preferably from 3% by mass to 7% by mass.

The heat-sensitive transfer image-receiving sheet of the present invention has at least one receptor layer (preferably at least two receptor layers) having a thermoplastic receptive polymer capable of receiving at least a dye.

Examples of preferable receptive polymers include vinyl-based resins such as polyvinyl acetate, ethylene vinyl acetate copolymer, vinyl chloride vinyl acetate copolymer, vinyl chloride acrylate copolymer, vinyl chloride methacrylate copolymer, polyacrylic ester, polystyrene, and acrylic polystyrene; acetal resins such as polyvinyl formal, polyvinyl butyral, and polyvinyl acetal; polyester resins such as polyethyleneterephthalate, polybutyleneterephthalate and polycaprolactone; polycarbonate-based resins; polyurethane-based resins; cellulose-based resins; polyolefin-based resins such as polypropylene; polyamide-based resins; and amino resins such as urea resins, melamine resins and benzoguanamine resins. These resins may be used optionally blending with each other in the range of compatibility.

It is further preferable, among these polymers, to use a polycarbonate, a polyester, a polyurethane, a polyvinyl chloride or a copolymer of vinyl chloride, a styrene-acrylonitrile copolymer, a polycaprolactone or a mixture of two or more of these. It is particularly preferable to use a polyester, a polyvinyl chloride or a copolymer of vinyl chloride, or a mixture of these.

The above-exemplified polymers may be dissolved in a proper organic solvent such as methyl ethyl ketone, ethyl acetate, benzene, toluene, and xylene so that they can be coated on a support. Alternatively, they may be added to a water-based coating liquid as latex polymer so that they can be coated on a support.

Further, the receptor layer may contain ultraviolet absorbents, release agents, sliding agents, antioxidants, antiseptics, and surfactants.

It is preferred to contain latex polymer in a receptor layer that is coated in the heat-sensitive transfer image-receiving sheet of the present invention.

The latex polymer for use in the receptor layer is a dispersion in which water-insoluble hydrophobic polymers are dispersed as fine particles in a water-soluble dispersion medium. The dispersed state may be one in which polymer is emulsified in a dispersion medium, one in which polymer underwent emulsion polymerization, one in which polymer underwent micelle dispersion, one in which polymer molecules partially have a hydrophilic structure and thus the molecular chains themselves are dispersed in a molecular state, or the like. The dispersed particles preferably have a mean average particle size (diameter) of about 1 to 50,000 nm, more preferably about 5 to 1,000 nm.

The glass transition temperature (Tg) of the latex polymer that can be used in the present invention is preferably −30° C. to 100° C., more preferably 0° C. to 80° C., further preferably 10° C. to 80° C., and further more preferably 15° C. to 70° C.

The glass transition temperature (Tg) is calculated according to the following equation:

1/Tg=Σ(Xi/Tgi)

wherein, assuming that the polymer is a copolymer composed of n monomers from i=1 to i=n, Xi is a mass fraction of the i-th monomer (ΣXi=l) and Tgi is a glass transition temperature (measured in absolute temperature) of a homopolymer formed from the i-th monomer. The symbol Σ means the sum of i=1 to i=n. The value of the glass transition temperature of a homopolymer formed from each monomer (Tgi) can be adopted from J. Brandrup and E. H. Immergut, “Polymer Handbook, 3rd. Edition”, Wiley-Interscience (1989).

In a preferable embodiment of the latex polymer used in the heat-sensitive transfer image-receiving sheet of the present invention, latex polymers such as acrylic-series polymers, polyesters, rubbers (e.g., SBR resins), polyurethanes, polyvinyl chloride copolymers including copolymers such as vinyl chloride/vinyl acetate copolymer, vinyl chloride/acrylate copolymer, and vinyl chloride/methacrylate copolymer; polyvinyl acetate copolymers including copolymers such as ethylene/vinyl acetate copolymer; and polyolefins, are preferably used. These latex polymers may be straight-chain, branched, or cross-linked polymers, the so-called homopolymers obtained by polymerizing single type of monomers, or copolymers obtained by polymerizing two or more types of monomers. In the case of the copolymers, these copolymers may be either random copolymers or block copolymers. The molecular weight of each of these polymers is preferably 5,000 to 1,000,000, and further preferably 10,000 to 500,000 in terms of number-average molecular weight.

The latex polymer according to the present invention is preferably exemplified by any one of polyester latexes; vinyl chloride latex copolymers such as vinyl chloride/acrylic compound latex copolymer, vinyl chloride/vinyl acetate latex copolymer, and vinyl chloride/vinyl acetate/acrylic compound latex copolymer, or arbitrary combinations thereof.

Examples of the vinyl chloride copolymer include those described above. Among these, VINYBLAN 240, VINYBLAN 270, VINYBLAN 276, VINYBLAN 277, VINYBLAN 375, VINYBLAN 380, VINYBLAN 386, VINYBLAN 410, VINYBLAN 430, VINYBLAN 432, VINYBLAN 550, VINYBLAN 601, VINYBLAN 602, VINYBLAN 609, VINYBLAN 619, VINYBLAN 680, VINYBLAN 680S, VINYBLAN 681N, VINYBLAN 683, VINYBLAN 685R, VINYBLAN 690, VINYBLAN 860, VINYBLAN 863, VINYBLAN 685, VINYBLAN 867, VINYBLAN 900, VINYBLAN 938 and VINYBLAN 950 (trade names, manufactured by Nissin Chemical Industry Co., Ltd.); and SE1320, S-830 (trade names, manufactured by Sumica Chemtex) are preferable.

The polyester-based latex is preferably exemplified by Vylonal MD1200, Vylonal MD1220, Vylonal MD1245, Vylonal MD1250, Vylonal MD1500, Vylonal MD1930, Vylonal MD1985 (trade names, manufactured by Toyobo Co., Ltd.).

Among these, vinyl chloride- based latex copolymers such as a vinyl chloride/acrylic compound latex copolymer, a vinyl chloride/vinyl acetate latex copolymer, a vinyl chloride/vinyl acetate/acrylic compound latex copolymer, are more preferable.

In the heat-sensitive transfer image-receiving sheet of the present invention, it is one of preferred embodiments of the present invention that the receptor layer contains a water-soluble polymer.

Herein, “water-soluble polymer” means a polymer which dissolves, in 100 g water at 20° C., in an amount of preferably 0.05 g or more, more preferably 0.1 g or more, further preferably 0.5 g or more, and particularly preferably 1 g or more. As the water-soluble polymers, natural polymers, semi-synthetic polymers and synthetic polymers are preferably used.

Among the water-soluble polymers which can be used in the heat-sensitive transfer image-receiving sheet of the present invention, the natural polymers and the semi-synthetic polymers will be explained in detail. Specific examples include the following polymers: plant type polysaccharides such as κ,-carrageenans, τ-carrageenans, λ-carrageenans, and pectins; microbial type polysaccharides such as xanthan gums and dextrins; animal type natural polymers such as gelatins, caseins; and cellulose-based polymers such as carboxymethylcelluloses, hydroxyethylcelluloses, and hydroxypropylcelluloses.

Among the natural polymers and the semi-synthetic polymers which can be used in the present invention, gelatin is preferable. Gelatin having a molecular weight of from 10,000 to 1,000,000 may be used in the present invention. Gelatin that can be used in the present invention may contain an anion such as Cl⁻ and SO₄²⁻, or alternatively a cation such as Fe²⁺, Ca²⁺, Mg²⁺, Sn²⁺, and Zn ²⁺. Gelatin is preferably added as an aqueous solution.

Of the water-soluble polymers that can be used in the heat-sensitive transfer image-receiving sheet of the present invention, examples of the synthetic polymers include polyvinyl pyrrolidone, polyvinyl pyrrolidone copolymers, polyvinyl alcohol, polyethylene glycol, polypropylene glycol, and water-soluble polyesters.

Among the synthetic polymers that can be used in the present invention, polyvinyl alcohols are preferable.

As the polyvinyl alcohol, there can be used various kinds of polyvinyl alcohols such as complete saponification products thereof, partial saponification products thereof, and modified polyvinyl alcohols. With respect to these polyvinyl alcohols, those described in Koichi Nagano, et al., “Poval”, Kobunshi Kankokai, Inc. are useful.

The viscosity of polyvinyl alcohol can be adjusted or stabilized by adding a trace amount of a solvent or an inorganic salt to an aqueous solution of polyvinyl alcohol, and use may be made of compounds described in the aforementioned reference “Poval”, Koichi Nagano et al., published by Kobunshi Kankokai, pp. 144-154. For example, a coated-surface quality can be improved by an addition of boric acid, and the addition of boric acid is preferable. The amount of boric acid to be added is preferably 0.01 to 40 mass %, with respect to polyvinyl alcohol.

Specific examples of the polyvinyl alcohols include completely saponificated polyvinyl alcohol such as PVA-105, PVA-110, PVA-117 and PVA-117H (trade names, manufactured by KURARAY CO.,LTD.); partially saponificated polyvinyl alcohol such as PVA-203, PVA-205, PVA-210 and PVA-220 (trade names, manufactured by KURARAY CO.,LTD.); and modified polyvinyl alcohols such as C-118, HL-12E, KL-118 and MP-203 (trade names, manufactured by KURARAY CO.,LTD.).

A preferable addition amount of the latex polymer is in the range of from 50% by mass to 98% by mass, more preferably from 70% by mass to 95% by mass, in terms of solid content of the latex polymer to the total polymer in the receptor layer.

When the receptor layer is formed by a multilayer structure, a solid content of latex polymer is preferably in the range of from 50% by mass to 98% by mass and furthermore preferably from 70% by mass to 95% by mass, in terms of the solid content of the latex polymer to the total polymer in the whole receptor layer.

The heat-sensitive transfer image-receiving sheet of the present invention may contain any ultraviolet absorbents. As the ultraviolet absorbents, use can be made of conventionally known inorganic or organic ultraviolet absorbents. As the organic ultraviolet absorbents, use can be made of non-reactive ultraviolet absorbents such as salicylate-series, benzophenone-series, benzotriazole-series, triazine-series, substituted acrylonitrile-series, and hindered amine-series ultraviolet absorbents; copolymers or graft polymers of thermoplastic resins (e.g., acrylic resins) obtained by introducing an addition-polymerizable double bond (eg., a vinyl group, an acryroyl group, a methacryroyl group), or an alcoholic hydroxyl group, an amino group, a carboxyl group, an epoxy group, or an isocyanate group, to the non-reactive ultraviolet absorbents, subsequently copolymerizing or grafting. In addition, disclosed is a method of obtaining ultraviolet-shielding resins by the steps of dissolving ultraviolet absorbents in a monomer or oligomer of the resin to be used, and then polymerizing the monomer or oligomer (JP-A-2006-21333). In this case, the ultraviolet absorbents may be non-reactive.

Of these ultraviolet absorbents, preferred are benzophenone-series, benzotriazole-series, and triazine-series ultraviolet absorbents. It is preferred that these ultraviolet absorbents are used in combination so as to cover an effective ultraviolet absorption wavelength region according to characteristic properties of the dye that is used for image formation. Besides, in the case of non-reactive ultraviolet absorbents, it is preferred to use a mixture of two or more kinds of ultraviolet absorbents each having a different structure from each other so as to prevent the ultraviolet absorbents from precipitation.

Examples of commercially available ultraviolet absorbents include TINUVIN-P (trade name, manufactured by Ciba-Geigy), JF-77 (trade name, manufactured by JOHOKU CHEMICAL CO., LTD.), SEESORB 701 (trade name, manufactured by SHIRAISHI CALCIUM KAISHA, LTD.), SUMISORB 200 (trade name, manufactured by Sumitomo Chemical Co., Ltd.), VIOSORB 520 (trade name, manufactured by KYODO CHEMICAL CO., LTD.), and ADKSTAB LA-32 (trade name, manufactured by ADEKA).

To the heat-sensitive transfer image-receiving sheet of the present invention, a release agent may be added to secure a releasing property between the heat-sensitive transfer sheet and the heat-sensitive transfer image-receiving sheet at the time of image printing.

As the release agent, there can be used, for example, solid waxes such as polyethylene wax, paraffin wax, fatty acid ester wax, and amide wax; and silicone oil, phosphoric ester-based compounds, fluorine-based surfactants, silicone-based surfactants, and other release agents known in this technical field. Of these release agents, preferred are fatty acid ester waxes, fluorine-based surfactants, and silicone-based compounds such as silicone-based surfactants, silicone oil and/or hardened products thereof.

Further, in the heat-sensitive transfer image-receiving sheet of the present invention, a surfactant may be contained in any of such layers as described above. Of these layers, it is preferable to contain the surfactant in the receptor layer and the intermediate layer.

An addition amount of the surfactant is preferably from 0.01% by mass to 5% by mass, more preferably from 0.01% by mass to 1% by mass, and especially preferably from 0.02% by mass to 0.2% by mass, based on the total solid content.

With respect to the surfactant, various kinds of surfactants such as anionic, nonionic and cationic surfactants are known. As the surfactant that can be used in the present invention, any known surfactants may be used. For example, it is possible to use surfactants as reviewed in “Kinosei kaimenkasseizai (Functional Surfactants)”, editorial supervision of Mitsuo Tsunoda, edition on August in 2000, Chapter 6. Of these surfactants, fluorine-containing anionic surfactants are preferred.

As the fluorine-containing anionic surfactants, ones having the following group are preferable.

—(CH₂)n-(CF₂)m-X

wherein, X represents a hydrogen atom or a fluorine atom; n represents an integer of 1 to 6; m represents an integer of 1 to 6. In this case, X is preferably a fluoride atom; n is preferably 1 or 2; m is preferably an integer of 2 to 4. Further, the atom to which the group —(CH₂)n-(CF₂)m-X bonds is preferably an oxygen atom, and surfactants containing at least two or more (preferably two) groups of —(CH₂)n-(CF₂)m-X in a molecule are preferable. Further, as an anion group in the fluorine-containing anion surfactants, —OSO₃⁻, —OSO₂⁻, and —CO₂⁻ are preferable, and —OSO₃⁻, and —OSO₂⁻ are more preferable, and —OSO₃⁻ are most preferable.

To the heat-sensitive transfer image-receiving sheet of the present invention, a matting agent may be added in order to prevent blocking, or to give a release property or a sliding property. The matting agent may be added on the same side as the coating side of the receptor layer, or on the side opposite to the coating side of the receptor layer, or on both sides.

Examples of the matting agent generally include fine particles of water-insoluble organic compounds and fine particles of water-insoluble inorganic compounds. In the present invention, the organic compound-containing fine particles are preferably used from the viewpoints of dispersion properties. In so far as the organic compound is incorporated in the particles, there may be organic compound particles consisting of the organic compound alone, or alternatively organic/inorganic composite particles containing not only the organic compound but also an inorganic compound. As the matting agent, there can be used organic matting agents described in, for example, U.S. Pat. No. 1,939,213, U.S. Pat. No. 2,701,245, U.S. Pat. No. 2,322,037, U.S. Pat. No. 3,262,782, U.S Pat. No. 3,539,344, and U.S. Pat. No. 3,767,448.

In the heat-sensitive transfer image-receiving sheet of the present invention, at least one compound represented by formula (I), (II) or (III) is preferably contained in any layer of the image-receiving sheet. Explanation of each of the formulae will be detailed below.

In formula (I), R¹ and R², which may be the same or different, each represent a hydrogen atom, a hydroxy group, or an alkyl group having 1 to 8 carbon atoms (e.g., methyl, ethyl, isopropyl, tert-butyl). X represents a hydrogen atom, a halogen atom (e.g., chlorine, bromine, fluorine), a nitro group, a cyano group, an aryl group (e.g., phenyl, naphthyl, preferable carbon number is 6 to 12), an alkyl group having 1 to 8 carbon atoms (e.g., methyl, ethyl, n-butyl, tert-octyl), an alkenyl group having 2 to 8 carbon atoms (e.g., allyl, propenyl), an aralkyl group (e.g., benzyl, phenethyl, preferable carbon number is 7 to 15), an alkoxy group (e.g., methoxy, n-butoxy, 2-methoxyethoxy, preferable carbon number is 1 to 8), —COR³, —SO₃R⁴, or —N(R⁵)R⁶. R³ and R⁴, which may be the same or different, each represent a hydrogen atom, -OM, an alkyl group having 1 to 8 carbon atoms (e.g., methyl, n-butyl, tert-octyl), an alkoxy group having 1 to 8 carbon atoms (e.g., methoxy, ethoxy, n-butoxy), or —N(R⁷)R⁸. R⁵ and R⁶, which may be the same or different, each represent a hydrogen atom, an alkyl group having 1 to 8 carbon atoms (e.g., methyl, ethyl, 2-ethylhexyl), —COR⁹, or —SO₂R¹⁰. R⁹ and R¹⁰, which may be the same or different, each represent an alkyl group having 1 to 8 carbon atoms (e.g., methyl, ethyl, 2-methoxyethyl), or —N(R¹¹)R¹². R⁷, R⁸, R¹¹ and R¹², which may be the same or different, each represent a hydrogen atom, or an alkyl group having 1 to 8 carbon atoms (e.g., methyl, ethyl, 2-ethylhexyl). M represents a hydrogen atom, an alkali metal atom (e.g., sodium, potassium), or atoms necessary to form a univalent cation (e.g., ammonium cation, phosphonium cation). 1 represents an integer of 2 to 6. m represents an integer of 1 to 4. n represents an integer of (6-m). Note that when a plurality of R¹, R², or X is present, the plurality of R¹, R², or X may be the same or different.

In the compounds represented by the above formula (I), a preferable carbon atom range of both the alkyl group represented by R¹, R² and the alkoxy group represented by X is 2 to 8.

Further, a preferable compound in the above formula (I) is the compound that carbon atom range of both the alkyl group having 1 to 8 carbon atoms represented by R¹, R² and the alkoxy group represented by X is 2 to 4, or the compound that X is either a hydrogen atom or an alkyl group having 1 to 8 carbon atoms, and R¹ and R² each are a hydrogen atom, an alkyl group having 1 to 8 carbon atoms, m is an integer of 1 or 2, and n is an integer of 4 or 5.

Next, representative specific examples of the compound represented by formula (I) will be shown below. However, the compounds represented by formula (I) that are used in the present invention are not intended to be limited to these compounds. The following exemplified compounds are widely sold on the market, so they are easily available.

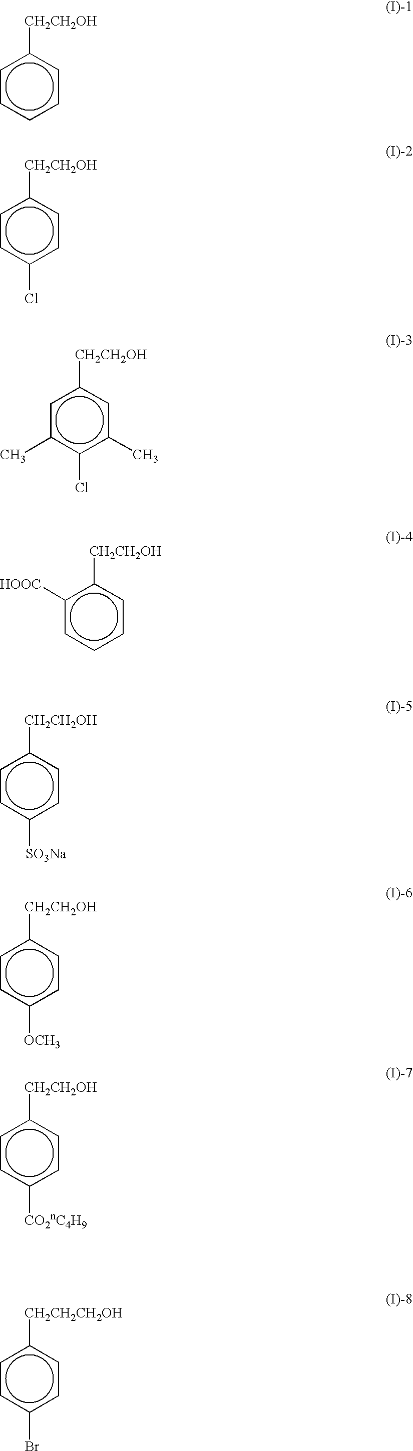

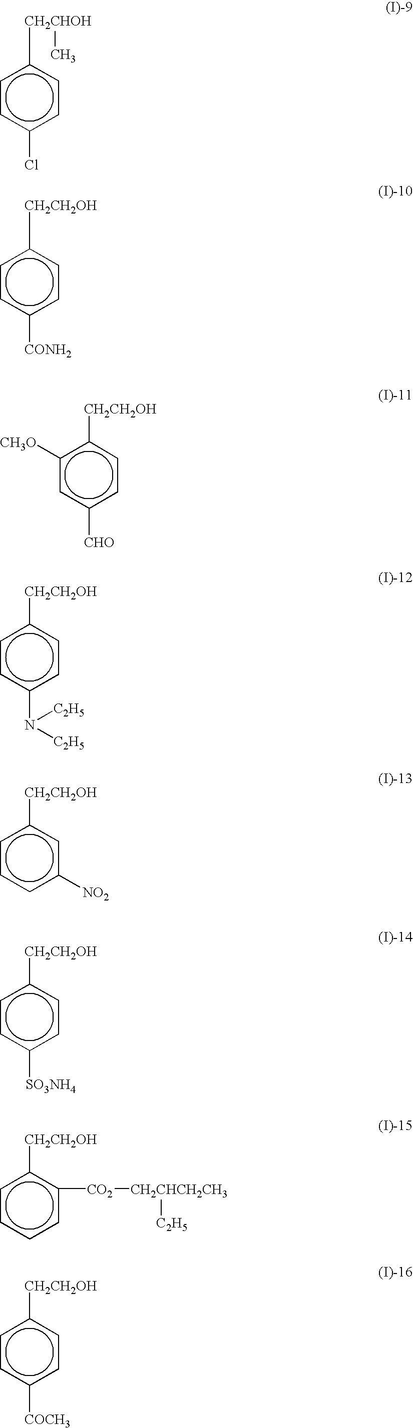

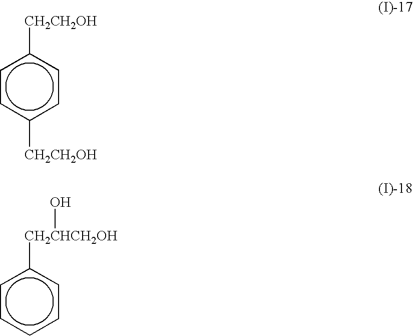

Next, the compounds represented by formula (II) will be described below.

R¹³ represents a hydrogen atom, a straight or branched chain, substituted or unsubstituted alkyl group having 1 to 8 carbon atoms (e.g., methyl, ethyl, tert-butyl, n-octadecyl, 2-hydroxyethyl, 2-carboxyethyl, 2-cyanoethyl, sulfobutyl, N,N-dimethylaminoethyl), a substituted or unsubstituted cycloalkyl group (e.g., cyclohexyl, 3-methylcyclohexyl, 2-oxocyclopentyl, preferable carbon number is 5 to 8), a substituted or unsubstituted alkenyl group (e.g., allyl, methylallyl, preferable carbon number is 5 to 8), a substituted or unsubstituted aralkyl group (e.g., benzyl, p-methoxybenzyl, o-chlorobenzyl, p-isopropylbenzyl, preferable carbon number is 7 to 15), a substituted or unsubstituted aryl group (e.g., phenyl, naphthyl, o-methylphenyl, m-nitrophenyl, 3,4-dichlorophenyl, preferable carbon number is 6 to 12), or a heterocyclic group (e.g., 2-imidazolyl, 2-furyl, 2-thiazolyl, 2-pyridyl, preferable carbon number is 0 to 12) or the following group,

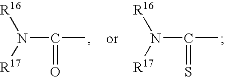

R¹⁴ and R¹⁵, which may be the same or different, each represent a hydrogen atom, a halogen atom (e.g., fluorine, chlorine, bromine), a substituted or unsubstituted alkyl group having 1 to 8 carbon atoms (e.g., methyl, ethyl, chloromethyl, 2-hydroxyethyl, tert-butyl, n-octyl,), a substituted or unsubstituted cycloalkyl group (e.g., cyclohexyl, 2-oxocyclopentyl, preferable carbon number is 5 to 8), a substituted or unsubstituted aryl group (e.g., phenyl, 2-methylphenyl, 3,4-dichlorophenyl, naphthyl, 4-nitrophenyl, 4-aminophenyl, 3-acetamidophenyl, preferable carbon number is 6 to 12), a cyano group, a heterocyclic group (e.g., 2-imidazolyl, 2-thiazolyl, 2-pyridyl, preferable carbon number is 0 to 12), a substituted or unsubstituted alkylthio group (e.g., methylthio, 2-cyanoethylthio, 2-ethoxycarbonylthio, preferable carbon number is 1 to 8), a substituted or unsubstituted alkylsulfoxy group (e.g., methylsulfoxy, 2-hydroxyethyl sulfoxy, preferable carbon number is 1 to 8), or a substituted or unsubstituted alkylsulfonyl group (e.g., methylsulfonyl, 2-bromoethylsulfonyl, preferable carbon number is 1 to 8). R¹⁴ and R¹⁵ may bind with each other to form an aromatic ring (e.g., benzene ring, naphthalene ring, preferable carbon number is 6 to 12).

R¹⁶ and R¹⁷, which may be the same or different, each represent a hydrogen atom, a substituted or unsubstituted alkyl group having 1 to 8 carbon atoms (e.g., methyl, ethyl, isopropyl, 2-cyanoethyl, 2-n-butoxycarbonylethyl), a substituted or unsubstituted aryl group (e.g., phenyl, naphthyl, 2-methoxyphenyl, m-nitrophenyl, 3,5-dichlorophenyl, 3-acetamidophenyl, preferable carbon number is 6 to 12), or a substituted or unsubstituted aralkyl group (e.g., benzyl, phenethyl, p-isopropylbenzyl, o-chlorobenzyl, m-methoxybenzyl, preferable carbon number is 7 to 15).

Further, a preferable embodiment of formula (II) is that R¹³ is a hydrogen atom, an alkyl group having 1 to 8 carbon atoms, and R¹⁴ and R¹⁵ bind with each other to form an aromatic ring.

Representative specific examples of the compound represented by formula (II) will be shown below. However, the compounds represented by formula (II) that are used in the present invention are not intended to be limited to these compounds. Some of the following exemplified compounds are sold on the market, so that they are easily available. Further, these compounds may be prepared according to the synthesis method described in the specification of French Patent 1,555,416.

(Exemplified Compound)

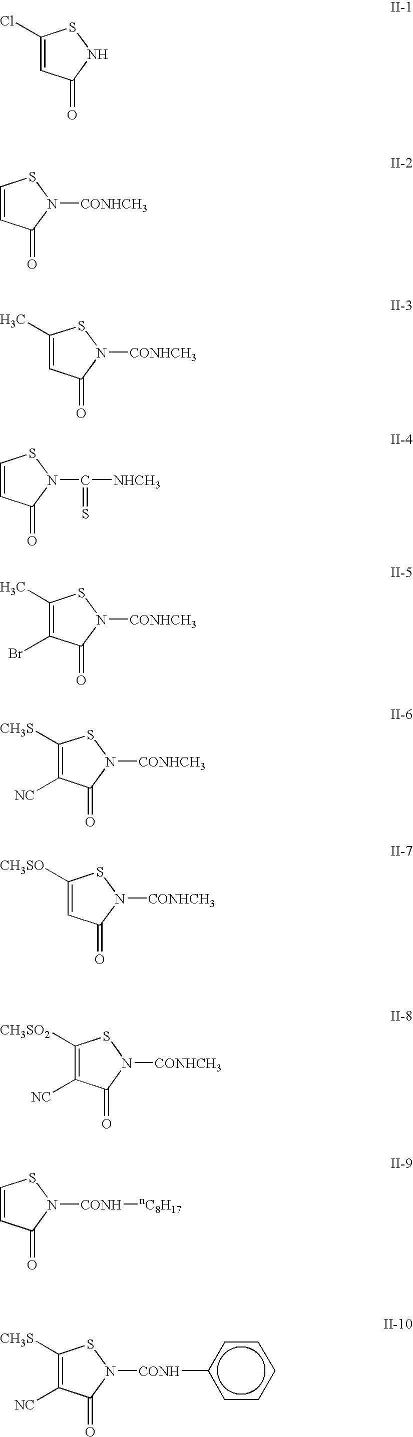

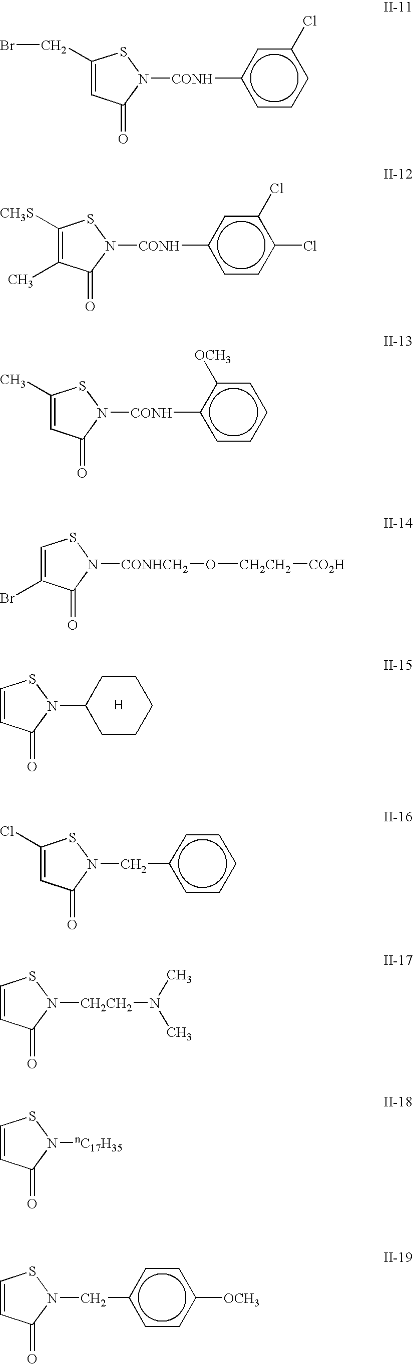

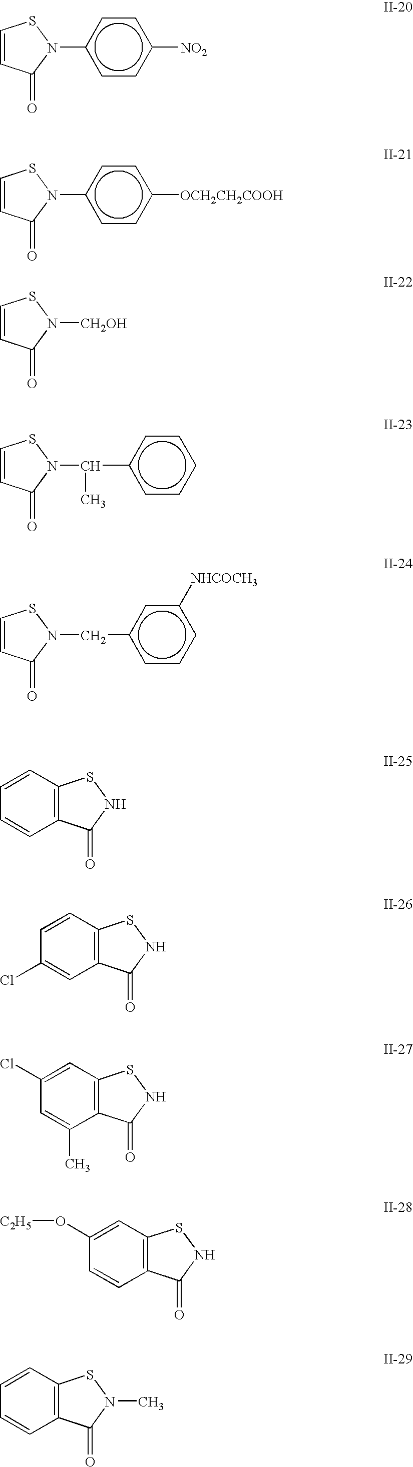

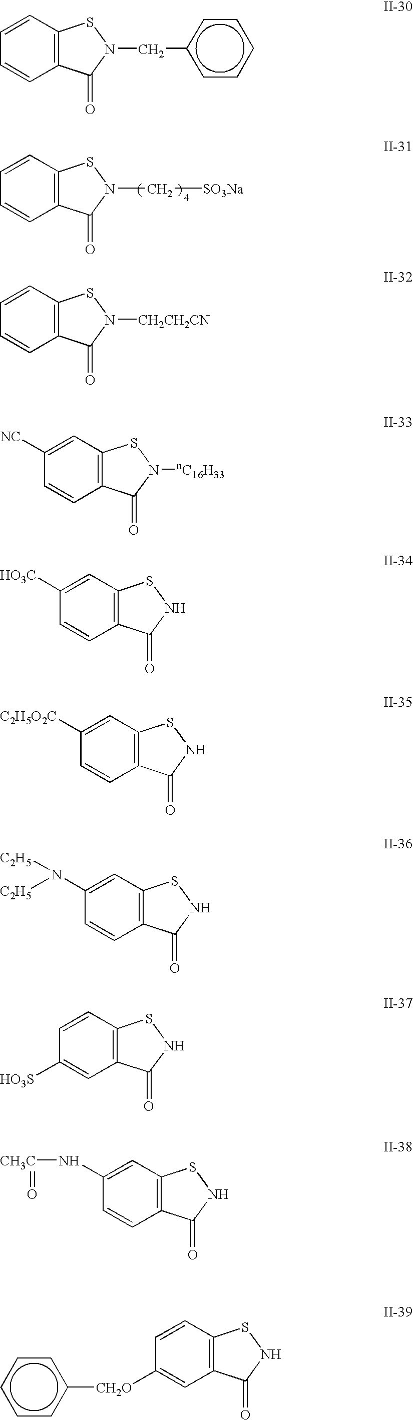

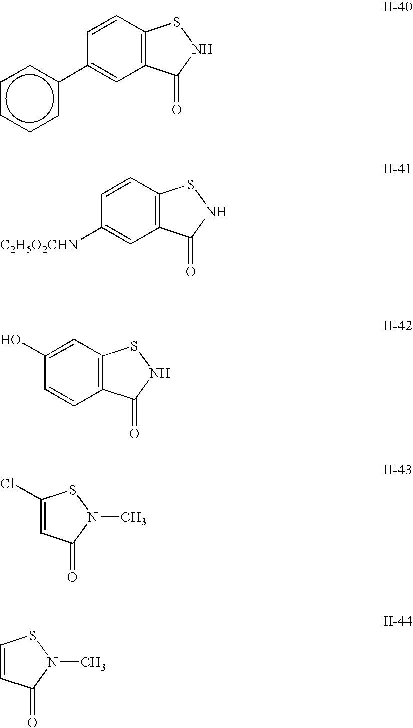

Next, the compounds represented by formula (III) will be described below. R¹⁸ represents a hydrogen atom, an alkyl group having 1 to 8 carbon atoms (e.g., methyl, ethyl, isopropyl), or a hydroxymethyl group. R¹⁹ represents a hydrogen atom, or an alkyl group having 1 to 8 carbon atoms (e.g., methyl, n-butyl, isopentyl). Of the alkyl group having 1 to 8 carbon atoms, an alkyl group having 1 to 5 carbon atoms is preferred. Especially, an alkyl group with one carbon atom is preferred.

Representative specific examples of the compound represented by formula (III) will be shown below. However, the compounds represented by formula (III) that are used in the present invention are not intended to be limited to these compounds.

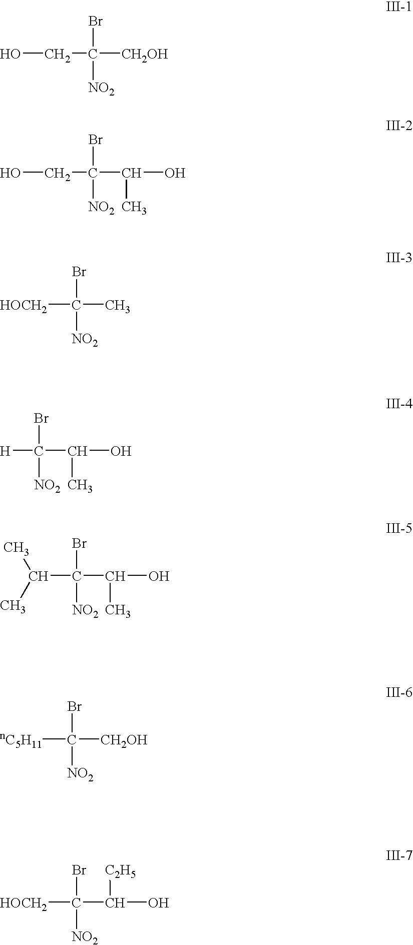

Some of these compounds are commercially available from SAN-AI OIL. Further, these compounds may be synthesized with reference to the following literatures.
(1) Henry Recuell des travaux chiniques des Rays-Bas,16,251.
(2) Mass.chemisches Zentralblatt.1899 1179.
(3) E.Schmidt.Berichte der Deutchen Chemischen Gesellschaft 397.
(4) E.Schmidt.ibid.55 317.
(5) Henry Chemiches Zentrablatt.1897 II 388.

In this case, it is preferred that synthesis of III-1 is performed according to literature (1), (2) or (3), and likewise III-2 is performed according to literature (2), and III-3 is performed according to literature (5), and III-4 is performed according to literature (2), respectively.

The compounds represented by formula (I), (II) or (III) are preferably water-soluble, and the total carbon number is preferably 20 or less, more preferably 15 or less.

The compounds represented by formula (I), (II) or (III) may be contained in the receptor layer, or the heat insulation layer, or alternatively both the receptor layer and the heat insulation layer.

An addition amount of the compound represented by formula (I), (II) or (III) is preferably in the range of from 0.01% by mass to 1% by mass, more preferably from 0.02% by mass to 0.5% by mass, furthermore preferably from 0.03% by mass to 0.1% by mass, respectively in terms of solid content after coating. If the addition amount is less than 0.01% by mass, it is difficult to obtain a sufficient effect that would be achieved by the addition of compound. Whereas, the addition amount that is more than 1% by mass tends to cause reduction in sensitivity. Accordingly, such outside ranges of the foregoing addition amount is not preferable.

The coating amount of the receptor layer is preferably 0.5 to 10 g/m² (solid basis, hereinafter, the amount to be applied in the present specification means a value on solid basis, unless otherwise specified). The film thickness of the receptor layer is preferably in the range of from 1 μm to 20 μm.

It is one of preferable embodiments of the present invention that an interlayer is formed between any two of a receptor layer, a heat insulation layer and a support. The interlayer may be formed between the receptor layer and the heat insulation layer, or the heat insulation layer and the support, or alternatively not only between the receptor layer and the heat insulation layer, but also between the heat insulation layer and the support. When an interlayer is disposed between the heat insulation layer and the support, the interlayer is sometimes called as an undercoat layer. As a function of the interlayer, there are exemplified white background adjustment, antistatic, provision of adhesion and provision of smoothness. However, the function is not limited to these properties. As a material that is used in the interlayer according to the present invention, there are exemplified latex polymer and water-soluble polymers similarly to the receptor layer and the heat insulation layer. As preferable embodiments of the latex polymer, acrylic-based polymers, polyesters, rubbers (e.g., SBR resins, MBR resins), polyurethanes, polyvinyl chloride copolymers including copolymers such as vinyl chloride/vinyl acetate copolymer, vinyl chloride/acrylate copolymer, and vinyl chloride/methacrylate copolymer; polyvinyl acetate copolymers including copolymers such as ethylene/vinyl acetate copolymer; and polyolefins, are preferably used. These latex polymers may be straight-chain, branched, or cross-linked polymers, the so-called homopolymers obtained by polymerizing single type of monomers, or copolymers obtained by polymerizing two or more types of monomers. In the case of the copolymers, these copolymers may be either random copolymers or block copolymers. The molecular weight of each of these polymers is preferably 5,000 to 1,000,000, and further preferably 10,000 to 500,000 in terms of number-average molecular weight.

Specific examples of the rubbers include LACSTAR 7310K, 3307B, 4700H, and 7132C (trade names, manufactured by Dainippon Ink & Chemicals Incorporated); Nipol Lx416, LX410, LX430, LX435, LX 110, LX415A, LX415M, LX438C, 2507H, LX303A, LX407BP series, V1004, and MH5055 (trade names, manufactured by Nippon Zeon Co., Ltd.); and SN-307, SR-103, SR-104, SR-107, SR-108, SR-110, SR-111, SR-112, SR-113, SR-114, SR-130, SR-140, SR-141, SR-142, MR-171, MR-172, MR-173, MR-174 and MR-180 (trade names, manufactured by NIPPON A&L INC.).

Examples of poly vinyl chlorides include G351 and G576 (trade names, manufactured by Nippon Zeon Co., Ltd.); VINYBLAN 240, 270, 277, 375, 386, 609, 550, 601, 602, 630, 660, 671, 683, 680, 680S, 681N, 685R, 277, 380, 381, 410, 430, 432, 860, 863, 865, 867, 900, 900GT, 938 and 950, SOLBIN C, SOLBIN CL, SOLBIN CH, SOLBIN CN, SOLBIN C5, SOLBIN M, SOLBIN MF, SOLBIN A, and SOLBIN AL (trade names, manufactured by Nissin Chemical Industry Co., Ltd.); S-LEC A, S-LEC C and S-LEC M (trade names, manufactured by Sekisui Chemical Co., Ltd.); and DENKA VINYL 1000GKT, DENKA VINYL 1000L, DENKA VINYL 1000CK, DENKA VINYL 1000A, DENKA VINYL 1000K2, DENKA VINYL 1000AS, DENKA VINYL 1000GS, DENKA VINYL 1000LT3, DENKA VINYL 1000D and DENKA VINYL 1000W (trade names, manufactured by Denki Kagaku Kogyo Kabushiki Kaisha).

It is a preferable embodiment of the present invention to use a water-soluble polymer as a binder of the interlayer. As the water-soluble polymer that can be preferably used in the interlayer according to the present invention, there are exemplified synthetic polymers, natural polymers and semi-synthetic polymers with a more preferable example being synthetic polymers.

Of the water-soluble polymers that can be preferably used in the intermediate layer of the present invention, examples of the synthetic polymers include polyvinyl pyrrolidone, polyvinyl pyrrolidone copolymers, polyvinyl alcohol, polyethylene glycol, polypropylene glycol, and water-soluble polyesters.

Among the synthetic polymers that can be used in the present invention, polyvinyl alcohols are preferable.

As the polyvinyl alcohol, there can be used various kinds of polyvinyl alcohols such as complete saponification products thereof, partial saponification products thereof, and modified polyvinyl alcohols. With respect to these polyvinyl alcohols, those described in Koichi Nagano, et al., “Poval”, Kobunshi Kankokai, Inc. are useful.

The viscosity of polyvinyl alcohol can be adjusted or stabilized by adding a trace amount of a solvent or an inorganic salt to an aqueous solution of polyvinyl alcohol, and use may be made of compounds described in the aforementioned reference “Poval”, Koichi Nagano et al., published by Kobunshi Kankokai, pp. 144-154. For example, a coated-surface quality can be improved by an addition of boric acid, and the addition of boric acid is preferable. The amount of boric acid to be added is preferably 0.01 to 40 mass %, with respect to polyvinyl alcohol.

Specific examples of the polyvinyl alcohols include completely saponificated polyvinyl alcohol such as PVA-105, PVA-110, PVA-117 and PVA-117H (trade names, manufactured by KURARAY CO.,LTD.); partially saponificated polyvinyl alcohol such as PVA-203, PVA-205, PVA-210 and PVA-220 (trade names, manufactured by KURARAY CO.,LTD.); and modified polyvinyl alcohols such as C-118, HL-12E, KL-118 and MP-203 (trade names, manufactured by KURARAY CO.,LTD.).

Next, the natural polymers and the semi-synthetic polymers will be explained in detail. Specific examples include the following polymers: plant type polysaccharides such as κ-carrageenans, τ-carrageenans, λ-carrageenans, and pectins; microbial type polysaccharides such as xanthan gums and dextrins; animal type natural polymers such as gelatins and caseins; and cellulose-based polymers such as carboxymethylcelluloses, hydroxyethylcelluloses, and hydroxypropylcelluloses.

Of the natural polymers and the semi-synthetic polymers that can be used in the present invention, gelatin is preferred. Gelatin having a molecular mass of from 10,000 to 1,000,000 may be used in the present invention.

Gelatin that can be used in the present invention may contain an anion such as Cl⁻ and SO₄²⁻, or alternatively a cation such as Fe²⁺, Ca²⁺, Mg²⁺, Sn²⁺, and Zn²⁺. Gelatin is preferably added as an aqueous solution.

A film thickness of the interlayer is in the range of from 1μm to 30 μm, preferably from 1 μm to 25 μm, and more preferably from 1 μm to 20 μm. Further, even though the interlayer may be formed by a single layer coating, it is more preferred that the interlayer is formed together with other layers by a simultaneous multilayer coating.

As the support that is used for the heat-sensitive transfer image-receiving sheet of the present invention, there may be used previously known supports with a preferable example being a water-proof support. The usage of the water-proof support enables to prevent the support from absorbing moisture thereto, so that a change in properties of the receptor layer with the lapse of time can be prevented. As the water-proof support, there may be, for example, a coat paper, a laminate paper and a synthetic paper with a preferable example being a laminate paper.

In the heat-sensitive transfer image-receiving sheet that is used in the present invention, if necessary, a curl adjusting layer is preferably formed. For the curl adjusting layer, for example, a polyethylene laminate and a polypropylene laminate may be used. Specifically, the curl adjusting layer may be formed in the same manner as described in, for example, JP-A-61-110135 and JP-A-6-202295.

In the heat-sensitive transfer image-receiving sheet that is used in the present invention, if necessary, a writing layer or a charge controlling layer may be disposed. For the writing layer and the charge control layer, an inorganic oxide colloid, an ionic polymer, or the like may be used. As the antistatic agent, any antistatic agents including cationic antistatic agents such as a quaternary ammonium salt and polyamine derivative, anionic antistatic agents such as alkyl phosphate, and nonionic antistatic agents such as fatty acid ester may be used. Specifically, the writing layer and the charge control layer may be formed in a manner similar to those described in the specification of Japanese Patent No. 3585585.

A method of producing a heat-sensitive transfer image-receiving sheet according to the present invention will be explained below.

In the method of producing the heat-sensitive transfer image-receiving sheet of the present invention, a receptor layer and a heat insulation are multilayer-coated simultaneously on a support.

It is known that in the case of producing a heat-sensitive transfer image-receiving sheet composed of plural layers having different functions from each other (for example, an air cell layer, a heat insulation layer, an intermediate layer, and a receptor layer) on a support, it may be produced by applying each layer successively one by one, or by overlapping the layers each already coated on the support, as shown in, for example, JP-A-2004-106283, JP-A-2004-181888 and JP-A-2004-345267. It has been known in photographic industries, on the other hand, that productivity can be greatly improved, for example, by providing plural layers through simultaneous multi-layer coating. For example, there are known methods, such as the so-called slide coating (slide coating method) and curtain coating (curtain coating method), as described in, for example, U.S. Pat. Nos. 2,761,791, 2,681,234, 3,508,947, 4,457,256 and 3,993,019; JP-A-63-54975, JP-A-61-278848, JP-A-55-86557, JP-A-52-31727, JP-A-55-142565, JP-A-50-43140, JP-A-63-80872, JP-A-54-54020, JP-A-5-104061, JP-A-5-127305, and JP-B-49-7050; and Edgar B. Gutoff, et al. and “Coating and Drying Defects: Troubleshooting Operating Problems”, John Wiley & Sons, 1995, pp. 101-103. However, in the silver halide photographic materials, it is not supposed to coat relatively large size of particles, which are easily deformed or aggromerated by coating, like the hollow particles according to the present invention. The present invention is of a different nature from the silver halide photographic materials in that the present invention adopts the coating of the layers of which main components are latex polymer.

According to the present invention, it is possible to not only drastically improve productivity, but also to reduce unevenness of the image by a simultaneous multilayer coating.

According to the image receiving sheet produced by the method of the present invention, image can be formed in combination with an ink sheet ( a heat-sensitive transfer sheet) by the dye diffusion transfer recording system. As the ink sheet, any arbitrary sheet known in the prior art can be used.

The present invention provides a method of producing a heat-sensitive transfer image-receiving sheet that is able to attain a high maximum density, to seldom cause a trouble in an image such as low spot (thin spot) and unevenness of the image, and moreover to avoid remaining traces of carrier roller. Further, the present invention provides a method of producing a heat-sensitive transfer image-receiving sheet that the image obtained is superior in fastness and a coat peeling seldom occurs.

The present invention will be described in more detail based on the following examples, but the invention is not intended to be limited thereto. In the following examples, the terms “part(s)” and “%” are values by mass, unless otherwise specified.

### EXAMPLES

### (Preparation of a Heat-Sensitive Transfer Sheet)

A polyester film 6.0 μm in thickness (trade name: Diafoil K200E-6F, manufactured by MITSUBISHI POLYESTER FILM CORPORATION), that was subjected to an easy adhesion-treatment on one surface of the film, was used as a support. The following back side-layer coating liquid was applied onto the support on the other surface that was not subjected to the easy adhesion-treatment, so that the coating amount based on the solid content after drying would be 1 g/m². After drying, the coated film was hardened by heat at 60° C.

A heat-sensitive transfer sheet was prepared by coating the following coating liquids on the easy adhesion layer coating side of the thus-prepared polyester film so that a yellow dye layer, a magenta dye layer, a cyan dye layer, and a protective layer laminate could be disposed sequentially in this area order. The coating amount of each dye layer based on the solid content was 0.8 g/m².

In the case of forming the protective layer laminate, after applying and drying of a coating liquid for a releasing layer on a substrate, a coating liquid for a protective layer was applied thereon and dried. After that, a coating liquid for an adhesive layer was applied and then dried.

Back side layer-coating liquid

| | |
|---|---|
| Acrylic-series polyol resin (trade name: ACRYDIC | 25.9 mass parts |
| A-801, manufactured by Dainippon Ink and Chemicals, | |
| Incorporated) | |
| Zinc stearate (trade name: SZ-2000, manufactured by | 0.43 mass part |
| Sakai Chemical Industry Co., Ltd.) | |
| Phosphate (trade name: PLYSURF A217, manufactured | 1.27 mass parts |
| by Dai-ichi Kogyo Seiyaku Co., Ltd.) | |
| Isocyanate (50% solution) (trade name: BURNOCK | 8.0 mass parts |
| D-800, manufactured by Dainippon Ink and Chemicals, | |
| Incorporated) | |
| Methyl ethyl ketone/Toluene (2/1, at mass ratio) | 64.1 mass parts |

Yellow-dye-layer-coating liquid

| | | |
|---|---|---|
| Dye compound (Y-1) | 3.9 | mass parts |
| Dye compound (Y-2) | 3.9 | mass parts |
| Polyvinylacetal resin (trade name: ESLEC KS-1, | 6.2 | mass parts |
| manufactured by Sekisui Chemical Co., Ltd.) | | |
| Polyvinylbutyral resin (trade name: | 2.1 | mass parts |
| DENKA BUTYRAL #6000-C, manufactured by | | |
| DENKI KAGAKU KOGYOU K.K.) | | |
| Releasing agent (trade name: X-22-3000T, | 0.05 | mass parts |
| manufactured by Shin-Etsu Chemical Co., Ltd.) | | |
| Releasing agent (trade name: TSF4701, manufactured | 0.03 | mass part |
| by MOMENTIVE Performance Materials Japan LLC.) | | |
| Matting agent (trade name: Flo-thene UF, | 0.15 | mass part |
| manufactured by | | |
| Sumitomo Seika Chemicals Co., Ltd.) | | |
| Methyl ethyl ketone/Toluene (2/1, at mass ratio) | 83.9 | mass parts |

Y-1

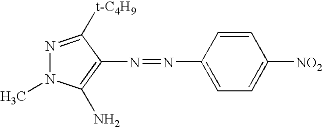

Y-2

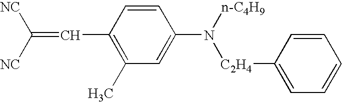

Magenta-dye-layer-coating liquid

| | | |
|---|---|---|
| Dye compound (M-1) | 0.1 | mass part |
| Dye compound (M-2) | 0.7 | mass part |
| Dye compound (M-3) | 6.6 | mass parts |
| Polyvinylacetal resin (trade name: | 8.1 | mass parts |
| ESLEC KS-1, manufactured by | | |
| Sekisui Chemical Co., Ltd.) | | |
| Polyvinylbutyral resin (trade name: | 0.2 | mass part |
| DENKA BUTYRAL #6000-C, manufactured by | | |
| DENKI KAGAKU KOGYOU K.K.) | | |
| Releasing agent (trade name: X-22-3000T, | 0.05 | mass part |
| manufactured by Shin-Etsu Chemical Co., Ltd.) | | |
| Releasing agent (trade name: TSF4701, | 0.03 | mass part |
| manufactured by MOMENTIVE Performance | | |
| Materials Japan LLC.) | | |
| Matting agent (trade name: Flo-thene UF, | 0.15 | mass part |
| manufactured by Sumitomo Seika | | |
| Chemicals Co., Ltd.) | | |
| Methyl ethyl ketone/Toluene | 83.9 | mass parts |
| (2/1, at mass ratio) | | |

M-1

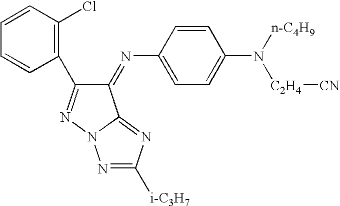

M-2

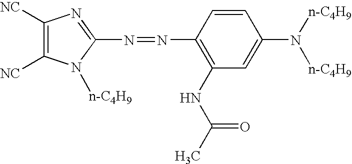

M-3

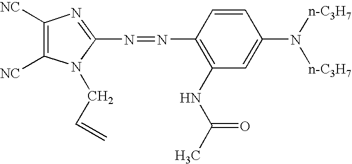

Cyan-dye-layer-coating liquid

| | | |
|---|---|---|
| Dye compound (C-1) | 1.2 | mass parts |
| Dye compound (C-2) | 6.6 | mass parts |
| Polyvinylacetal resin (trade name: ESLEC KS-1, | 7.5 | mass parts |
| manufactured by Sekisui Chemical Co., Ltd.) | | |
| Polyvinylacetal resin (trade name: | 0.8 | mass part |
| DENKA BUTYRAL #6000-C, manufactured by | | |
| DENKI KAGAKU KOGYOU K.K.) | | |
| Releasing agent (trade name: X-22-3000T, | 0.05 | mass part |
| manufactured by Shin-Etsu Chemical Co., Ltd.) | | |
| Releasing agent (trade name: TSF4701, | 0.03 | mass part |
| manufactured by MOMENTIVE Performance | | |
| Materials Japan LLC.) | | |
| Matting agent (trade name: Flo-thene UF, | 0.15 | mass part |
| manufactured by | | |
| Sumitomo Seika Chemicals Co., Ltd.) | | |
| Methyl ethyl ketone/Toluene (2/1, at mass ratio) | 83.9 | mass parts |

C-1

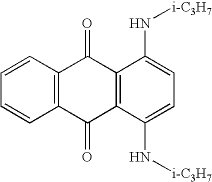

C-2

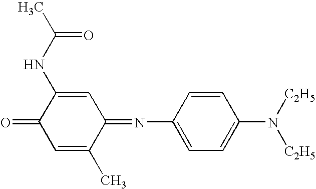

### (Transfer Protective Layer Laminate)

On the same polyester film as used in the preparation of the dye layers as described above, coating liquids of a releasing layer, a protective layer and an adhesive layer each having the following composition was coated, to form a transfer protective layer laminate. Coating amounts of the releasing layer, the protective layer and the adhesive layer after drying were 0.3 g/m², 0.5 g/m² and 2.2 g/m², respectively.

Releasing layer-coating liquid

| | |
|---|---|
| Modified cellulose resin (trade name: L-30, manufactured | 5.1 mass parts |
| by DAICEL CHEMICAL INDUSTRIES, LTD.) | |
| Methyl ethyl ketone | 94.9 mass parts |

Protective layer-coating liquid

| | |
|---|---|
| Acrylic resin solution (Solid content: 40%) (trade | 90.1 mass parts |
| name: UNO-1, manufactured by Gifu Ceramics Limited) | |
| Methanol/Isopropanol (1/1, at mass ratio) | 9.9 mass parts |

Adhesive layer-coating liquid

| | | |
|---|---|---|
| Acrylic resin (trade name: DIANAL BR-77, | 24.9 | mass parts |
| manufactured by MITSUBISHI RAYON CO., LTD.) | | |
| The following ultraviolet absorber UV-1 | 1 | mass part |
| The following ultraviolet absorber UV-2 | 2 | mass parts |
| The following ultraviolet absorber UV-3 | 1 | mass part |
| The following ultraviolet absorber UV-4 | 1 | mass part |
| PMMA fine particles (polymethyl methacrylate | 0.4 | mass part |
| fine particles) | | |
| Methyl ethyl ketone/Toluene (2/1, at mass ratio) | 70.1 | mass parts |

(UV-1)

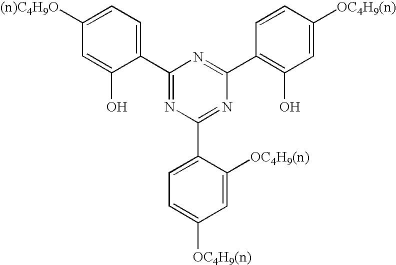

(UV-2)

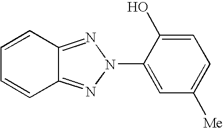

(UV-3)

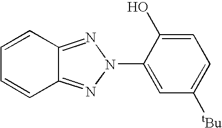

(UV-4)

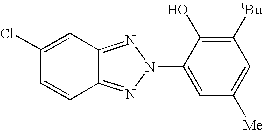

### (Preparation of a Heat Sensitive Image-Receiving Sheet)

A paper support, on both sides of which polyethylene was laminated, was subjected to corona discharge treatment on the surface thereof, and then a gelatin undercoat layer containing sodium dodecylbenzenesulfonate was disposed on the treated surface. A subbing layer, an insulation layer, a lower receptor layer and an upper receptor layer each having the following composition were simultaneously multilayer-coated on the gelatin undercoat layer, in the state that the subbing layer, the heat insulation layer, the lower receptor layer and the upper receptor layer were laminated in this order from the side of the support, by a method illustrated in FIG. 9 in U.S. Pat. No.2,761,791. The coating was performed so that coating amounts of the subbing layer, the heat insulation layer, the lower receptor layer, and the upper receptor layer after drying would be 6.7 g/m², 8.7 g/m², 2.6 g/m² and 2.7 g/m², respectively. The following compositions are presented by mass parts as solid contents.

Further, Tg of the resin contained in each of latex was measured using a thermogravimetric differential thermal analytical instrument (TG-DTA 320 manufactured by SII).

Upper receptor layer

| | | |
|---|---|---|
| Vinyl chloride-series latex (trade name: Vinybran 900, | 22.1 | mass parts |
| manufactured by Nissin Chemicals Co., Ltd.) | | |
| Vinyl chloride-series latex (trade name: Vinybran 276, | 2.3 | mass parts |
| manufactured by Nissin Chemicals Co., Ltd.) | | |
| Gelatin (10% solution) | 2.0 | mass parts |
| The following ester-series wax EW-1 | 2.0 | mass parts |
| The following surfactant F-1 | 0.07 | mass part |
| The following surfactant F-2 | 0.36 | mass part |
| Exemplified compound II-25 | 0.03 | mass part |

Lower receptor layer

| | |
|---|---|
| Vinyl chloride-series latex (trade name: Vinybran 690, | 12.1 mass parts |
| manufactured by Nissin Chemicals Co., Ltd.) | |
| Vinyl chloride-series latex (trade name: Vinybran 900, | 12.1 mass parts |
| manufactured by Nissin Chemicals Co., Ltd.) | |
| Gelatin (10% solution) | 10.0 mass parts |
| The following surfactant F-1 | 0.04 mass part |
| Exemplified compound II-25 | 0.03 mass part |

Heat insulation layer (film thickness after drying is 12.2 μm)

| | |
|---|---|
| Hollow latex polymer particles (trade name: MH5055, | 60.0 mass parts |
| manufactured by Nippon Zeon Co., Ltd.) | |
| average particle diameter 0.5 μm, hollow ratio 55%, | |
| Tg = 105° C. | |
| Styrene butadiene latex (trade name: LX415M, | 11.2 mass parts |
| manufactured by Nippon Zeon Co., Ltd.) | |
| Tg = 27° C. | |

Subbing layer

| | | |
|---|---|---|
| Polyvinyl alcohol (trade name: POVAL PVA 205, | 6.7 | mass parts |
| manufactured by Kuraray) | | |
| Styrene butadiene rubber latex (trade name: SN-307, | 60.1 | mass parts |
| manufactured by NIPPON A & L INC) | | |
| The following surfactant F-1 | 0.03 | mass part |

(EW-1)

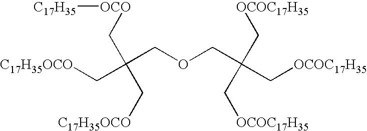

(F-1)

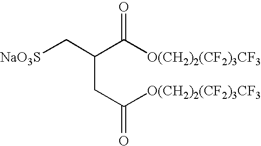

F-2

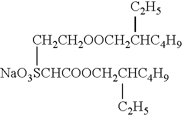

Sample No. 102 was prepared in the same manner as Sample 101, except that the styrene-butadiene latex in the heat insulation layer was replaced by LX 430 (trade name, a product of Nippon Zeon, Tg=12° C.), and the heat insulation layer was coated so that a coating amount of the solid content after drying would be the same.

Sample No. 103 was prepared in the same manner as Sample 101, except that the styrene-butadiene latex in the heat insulation layer was replaced by Vinybran 690 (trade name, manufactured by Nissin Chemicals Co., Ltd., Tg=46° C.), and further adding 1 mass part of gelatin, and the heat insulation layer was coated so that a coating amount of the solid content after drying would be the same.

Sample No. 104 was prepared in the same manner as Sample No. 103, except that Vinybran 690 was replaced by Vinybran 900 (trade name, manufactured by Nissin Chemicals Co., Ltd., Tg=70° C.), and the heat insulation layer was coated so that a coating amount of the solid content after drying would be the same.

Sample No. 105 was prepared in the same manner as Sample No. 103, except that Vinybran 690 was replaced by latex polymer containing a resin of Tg=87 ° C. prepared by the following method, and the heat insulation layer was coated so that a coating amount of the solid content after drying would be the same.

The latex polymer was prepared as described below.

In a pressure-tight stainless container, ion exchange water (170 mass parts) and sodium lauryl sulfate (3.0 mass parts) were placed, and air in the container was substituted with a nitrogen gas for 30 min. Thereafter, vinyl chloride monomer was added and a temperature was elevated to 45 ° C., followed by addition of sodium persulfate (0.2 mass part) with stirring for 2 hours to complete polymerization. Thereafter, after adjusting p H to 7.5 with ammonia, SUMIRISER GP (0.01 mass part) was added to prepare vinyl chloride latex.

Coating liquid compositions of Sample Nos. 101 to 105 were changed so that the percent by mass (the ratio of the solid) of hollow particles in the heat insulation layer would be 45%. Thus-coated samples were designated Sample Nos. 106 to 110, respectively.

Sample No. 111 was prepared in the same manner as Sample No. 103, except that each of the subbing layer, the heat insulation layer, the lower receptor layer and the upper receptor layer that was sequentially coated and dried using a slide coater according to the aqueous sequential coating.

Sample No. 112 was prepared in the same manner as Sample No. 103, except that the subbing layer and the heat insulation layer were coated according to the aqueous simultaneous coating similar to Sample No. 101 and then a receptor layer was coated on the heat insulation layer using the solvent coating liquid set forth below.

Sample No. 103 was preserved for 16 hours under the temperature and humidity conditions at 25° C. and 10% R H so that the moisture content would be 1.8%. Separately, Sample No. 103 was preserved for 16 hours under the temperature and humidity conditions at 25° C. and 70% R H so that the moisture content would be 8.3%. Thus-obtained samples were designated Sample Nos. 113 and 114.

Sample No. 115 was prepared in the same manner as Sample No. 103, except that the compound represented by II-25 was omitted from the lower receptor layer and the upper receptor layer, respectively.

Sample No. 116 was prepared in the same manner as Sample No. 103, except that the subbing layer was omitted and other layers were coated according to the simultaneous multilayer coating similar to Sample No. 101.

A sample was prepared in the same manner as Sample No. 103, except that a heat insulation layer coating liquid from which latex of hollow polymer particles was omitted was coated so that the solid content after drying would be the same. However, the print sensitivity of the thus-obtained sample was so low that it was difficult to perform evaluation of properties as described below.

### (Preparation of Solvent-Coating Type Image-Receiving Sheet; Sample No. 112)

The following solvent-type receptor coating liquid was coated using a bar coater. The coating was performed so that a coating amount after coating would be 4.0 g/m². Each layer was dried at 110° C. for 30 sec.

Receptor layer

| | | |
|---|---|---|
| Vinyl chloride/vinyl acetate resin (Trade name: Solbin | 100 | mass parts |
| A, manufactured by Nissin Chemicals Co., Ltd.) | | |
| Amino-modified silicone (Trade name: X22-3050C, | 5 | mass parts |
| manufactured by Shin-Etsu Chemical Co., Ltd.) | | |
| Epoxy-modified silicone (Trade name: X22-300E, | 5 | mass parts |
| manufactured by Shin-Etsu Chemical Co., Ltd.) | | |
| Methyl ethyl ketone/Toluene (1/1, at mass ratio) | 400 | mass parts |

### (Image Formation)

Using the aforementioned ink sheet and image-receiving sheet, al 52 mm×102 mm size image was output by means of a thermal transfer type printer A (ASK 2000 manufactured by FUJI FILM CORPORATION) or a thermal transfer type printer B (the printer described in FIG. 6 of JP-A-5-278247). Herein, a carry speed of the thermal transfer type printer A was 8 sec per sheet. With respect to the thermal transfer type printer B, printings were performed by setting so that the carry speed of the heat-sensitive transfer image-receiving sheet at time of printing would be 5 sec per sheet (high speed) and 50 sec per sheet (low speed), respectively. At this time, calorific value of the thermal head was controlled so as to give a total heat quantity equivalent to the heat value generating at the time of printing by means of the thermal transfer type printer A.

### (Evaluation of Properties)

Evaluation of properties was performed with respect to the following items:

### (D Max)

An image with D max (black maximum density) was output using the printer A to measure the maximum transfer density. The values obtained by a visual densitometry were shown in Table 1 in terms of relative values, assuming the value of Sample No. 101 to be 100. The larger the value is, the greater the depth of image. The image with a great depth is preferred. The visual density was measured using Photographic Densitometer (trade name, manufactured by X-Rite Incorporated).

### (Image Uniformity, Image Turbulence)

Five (5) copies of the print with a visual density of 1.0 were successively output using the printers A and B (high speed and low speed), respectively. A low spot (thin spot) and unevenness of the image generating in the thus-copied print were defined as image turbulence. The presence of the image turbulence was examined visually. The evaluation was performed by 15 testers according to the following criteria. The mean point of the evaluation was calculated.
5: The level at which no image turbulence is appreciated on the print, and there is practically no problem.
4: The level at which almost no image turbulence is appreciated on the print, and there is practically no problem.
3: The level at which image turbulence is appeared on the print, but there is practically no problem.
2: The level at which image turbulence is appeared in places on the print, so that there is practically problem.
1: The level at which image turbulence is intensely appeared on the print, so that there is practically problem.

### (Traces of Carrier Roller)

Five (5) copies of the print with a visual density of 1.0 were successively output using the printers A and B in a high speed mode, respectively. The presence of the traces of carrier roller generating in the copied print was examined visually. The evaluation was performed by 15 testers according to the following criteria. The mean point of the evaluation was calculated.
5: The level at which no roller trace is appreciated on the print, and there is practically no problem.
4: The level at which almost no roller trace is appreciated on the print, and there is practically no problem.
3: The level at which a roller trace is appeared on the print, but there is practically no problem.
2: The level at which roller traces are appeared in places on the print, so that there is practically problem.
1: The level at which roller traces are intensely appeared on the print, so that there is practically problem.

Further, the moisture content of each of the samples was measured according to the method defined by J I S P 8127. The results are shown in the following Table 1.

TABLE 1

| | Heat | | | | | | | |
|---|---|---|---|---|---|---|---|---|
| | Insulation | Hollow Particles | | | | Moisture | | |
| Sample | Layer Tg | Content (% by | | Image | Roller | Content | | |
| No. | (° C.) | mass) | Dmax | Turbulence | Trace | (%) | Coating Method | Remarks |
| 101 | 27 | 70 | 100 | 4.4 | 4.2 | 5.1 | Simultaneous | This invention |
| 102 | 12 | 70 | 79 | 3.1 | 3.2 | 5.2 | Simultaneous | Comparative example |
| 103 | 46 | 70 | 110 | 4.3 | 4.4 | 4.9 | Simultaneous | This invention |
| 104 | 70 | 70 | 106 | 4.0 | 4.1 | 5.1 | Simultaneous | This invention |
| 105 | 87 | 70 | 108 | 1.4 | 2.4 | 5.0 | Simultaneous | Comparative example |
| 106 | 27 | 45 | 95 | 4.1 | 4.3 | 5.0 | Simultaneous | This invention |
| 107 | 12 | 45 | 66 | 2.9 | 3.4 | 5.1 | Simultaneous | Comparative example |
| 108 | 46 | 45 | 104 | 4.2 | 4.4 | 4.9 | Simultaneous | This invention |
| 109 | 70 | 45 | 101 | 4.1 | 4.0 | 5.1 | Simultaneous | This invention |
| 110 | 87 | 45 | 102 | 2.1 | 2.3 | 4.9 | Simultaneous | Comparative example |
| 111 | 46 | 70 | 88 | 2.9 | 2.7 | 5.0 | Sequential | Comparative example |
| 112 | 46 | 70 | 79 | 2.8 | 2.6 | 3.6 | * | Comparative example |
| 113 | 46 | 70 | 105 | 3.7 | 3.5 | 1.8 | Simultaneous | This invention |
| 114 | 46 | 70 | 104 | 3.4 | 3.8 | 8.3 | Simultaneous | This invention |
| 115 | 46 | 70 | 94 | 3.1 | 3.0 | 5.0 | Simultaneous | This invention |
| 116 | 46 | 70 | 92 | 3.0 | 3.1 | 5.1 | Simultaneous | This invention |

* After coating and drying a subbing layer and a heat insulation layer according to the aqueous simultaneous multilayer coating, a receptor layer was coated thereon.
* “Simultaneous” means an aqueous simultaneous multilayer coating, and “Sequential” means a sequential coating.

From the results shown in Table 1, the followings are understood:

According to the samples of the present invention wherein the heat insulation layer contains hollow particles and resins of Tg in the range from 20 ° C. to 80° C., and the heat insulation layer and the receptor layer were formed according to the aqueous simultaneous multilayer coating, high maximum density, excellent image evenness and improvement of roller trace are achieved. More preferably, in Sample Nos. 101 and 103 with a high solid content of the hollow particles in the heat insulation layer, it is possible to obtain an image having a high maximum density without deteriorating both image evenness and quality of roller trace. In Sample No. 103 in which the moisture content is within a more preferable range of the present invention, both the image evenness and the quality of roller trace are improved.

Having described our invention as related to the present embodiments, it is our intention that the invention not be limited by any of the details of the description, unless otherwise specified, but rather be construed broadly within its spirit and scope as set out in the accompanying claims.

What we claim is:

1. A method of producing a heat-sensitive transfer image-receiving sheet having, on a support, a heat insulation layer and a receptor layer, comprising a step of:
forming both the heat insulation layer and the receptor layer by an aqueous simultaneous multilayer coating;
wherein the heat insulation layer comprises at least one kind of hollow polymer particles and at least one resin having a glass transition temperature (Tg) in the range from 20 ° C. to 80° C.

2. The method of producing a heat-sensitive transfer image-receiving sheet according to claim 1, wherein a solid content of the hollow polymer particles in the heat insulation layer is in the range of from 50% by mass to 95% by mass.

3. The method of producing a heat-sensitive transfer image-receiving sheet according to claim 1, wherein a moisture content of the image-receiving sheet measured according to JIS P 8127 is in the range of from 2% by mass to 8% by mass.

4. The method of producing a heat-sensitive transfer image-receiving sheet according to claim 1, wherein at least one compound represented by formula (I), (II) or (III) is contained in any one of the heat insulation layer and the receptor layer: 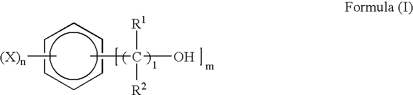
wherein R¹ and R², which may be the same or different, each represent a hydrogen atom, a hydroxy group, or an alkyl group having 1 to 8 carbon atoms;
X represents a hydrogen atom, a halogen atom, a nitro group, a cyano group, an aryl group, an alkyl group having 1 to 8 carbon atoms, an alkenyl group having 2 to 8 carbon atoms, an aralkyl group, an alkoxy group, —COR³, —SO₃R⁴, or —N(R⁵)R⁶;
R³ and R⁴, which may be the same or different, each represent a hydrogen atom, -OM, an alkyl group having 1 to 8 carbon atoms, an alkoxy group having 1 to 8 carbon atoms, or —N(R⁷)R⁸;
R⁵ and R⁶, which may be the same or different, each represent a hydrogen atom, an alkyl group having 1 to 8 carbon atoms, —COR⁹, or —SO₂R¹⁰;
R⁹ and R¹⁰, which may be the same or different, each represent an alkyl group having 1 to 8 carbon atoms, or —N(R¹¹)R¹²,
R⁷, R⁸, R¹¹ and R¹², which may be the same or different, each represent a hydrogen atom, or an alkyl group having 1 to 8 carbon atoms;
M represents a hydrogen atom, an alkali metal atom, or atoms necessary for forming a univalent cation;
1 represents an integer of 2 to 6;
m represents an integer of 1 to 4;
n represents an integer of (6-m);
and when a plurality of R¹, R² or X are present, the plurality of R¹, R² or X may be different from each other respectively; 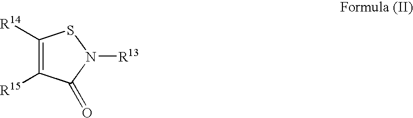
wherein R¹³ represents a hydrogen atom, an alkyl group having 1 to 8 carbon atoms, an alkenyl group, an aralkyl group, an aryl group, a heterocyclic group or the following group 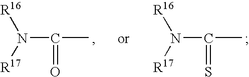
R¹⁴ and R¹⁵, which may be the same or different, each represent a hydrogen atom, a halogen atom, an alkyl group having 1 to 8 carbon atoms, an aryl group, a cyano group, a heterocyclic group, an alkylthio group, an alkylsulfoxyl group or an alkylsulfonyl group, and R¹⁴ and R¹⁵ may bond together to form an aromatic ring;
R¹⁶ and R¹⁷, which may be the same or different, each represent a hydrogen atom, an alkyl group having 1 to 8 carbon atoms, an aryl group, or an aralkyl group; 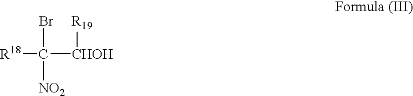
wherein R¹⁸ represents a hydrogen atom, an alkyl group having 1 to 8 carbon atoms, or a hydroxymethyl group; and
R¹⁹ represents a hydrogen atom or an alkyl group having 1 to 8 carbon atoms.

5. The method of producing a heat-sensitive transfer image-receiving sheet according to claim 1, wherein an interlayer is disposed between the support and the heat insulation layer, or between the heat insulation layer and the receptor layer.
